(19) United States
(12) Patent Application Publication
(10) Pub. No.: US 2026/0013973 A1
(43) Pub. Date: Jan. 15, 2026

(54) DISTALIZER APPLIANCE

(71) Applicant: Nile M. Davis, Mesa, AZ (US)

(72) Inventor: Nile M. Davis, Mesa, AZ (US)

(21) Appl. No.: 19/265,021

(22) Filed: Jul. 10, 2025

Related U.S. Application Data
(60) Provisional application No. 63/669,499, filed on Jul. 10, 2024.

(51) Int. Cl. A61C 7/30; A61C 7/28

(52) U.S. Cl. CPC A61C 7/30; A61C 7/282

(57) ABSTRACT

A distalizer appliance is provided. The distalizer appliance uses a molar bracket, a bicuspid bracket, and a rod. A spring is secured between an end of the rod and a fastener secured on a jaw of a patient. The molar bracket and the bicuspid bracket are secured to a molar and a bicuspid, via bonding pads. The molar bracket acts as a fulcrum for the rod in order to drive the molar distally and the bicuspid bracket acts to guide the rod.

### CROSS REFERENCE TO RELATED APPLICATION

This application claims priority to U.S. Provisional Patent Application 63/669,499, filed Jul. 10, 2024, the disclosure of which is hereby incorporated entirely herein by reference.

### BACKGROUND OF THE INVENTION

### Technical Field

This invention relates generally to an orthodontic appliance and more particularly to a distalizer appliance.

### State of the Art

Orthodontics is a specialty within dentistry that focuses on growth, modification, and movement of growing and stable jaw bones and dentition to create a balanced occlusion (bite) for function, esthetics, stability, and health. One of the more common movements and one of the most difficult to attain, is a backward or “distal” movement of teeth in their corresponding dental arches. This movement is required for a majority of patients. Over the last century, orthodontics has undergone many changes as technology and science have been developed to improve the orthodontist's ability to treat patients with newer appliances and techniques. No matter what improvements have been made, certain limitations exist due to patient factors beyond the control of the orthodontist.

One of the biggest factors in orthodontics treatment is patient compliance. Certain movements have historically relied on the use of appliances such as headgear, elastics, and other functional appliances to distalize teeth and/or help control jaw growth. When patients have not complied with the instructions given as to the use of these appliances, the required movements needed are not achieved. The orthodontist has therefore been required to do one of the following: accept the fact that certain movements will not be achieved and thus a less than ideal result; plead with the patient over and over again after several months to attempt to motivate the patient to cooperate; change the treatment plan significantly to the likely removal of teeth to accomplish certain goals; and/or attempt a different appliance in the hopes that this will work better. Due to these many challenges, new appliances and techniques have been developed to significantly reduce the need for patient compliance.

Some of the new appliances created work very well and with significantly improved outcomes. Even with improvements, however, some challenges still remain including how effective and efficient the appliance is to achieve desired goals; the associated costs; the time and work required to produce and place these appliances initially; patient comfort while the appliance is worn; and/or breakage of the appliance followed by repair and/or replacement in a timely manner. The challenges are clearly interrelated. For example, an appliance can be made to never (or almost never) break but requires multiple patient visits and is expensive. Another such appliance may be placed directly on the existing braces at a low cost but be ineffective if the appliance or the underlying braces are broken, require a lengthy patient visit for repair, and/or is uncomfortable for the patient. Still another such appliance may be made to achieve desired results in a short time frame but requires a lot of patient time or lab work and creates other unwanted movements that will need to be corrected later. Further, if or when the appliance breaks, a new appliance must be made and/or replaced due to the inability of reuse, thus increasing costs.

Accordingly, there is a need for a low cost, effective, easy to use and comfortable appliance for use in orthodontics.

### SUMMARY OF THE INVENTION

The present invention relates to a distalizer appliance for distally moving a molar and a bicuspid. The distalizer appliance uses a molar bracket, a bicuspid bracket, and a rod. The distalizer appliance of the present invention may be installed in one appointment. The distalizer appliance does not require patient cooperation, other than appliance care. The distalizer appliance may be used any time during orthodontic treatment and is easily repairable.

An embodiment includes a distalizer appliance comprising a first bracket having a first bonding pad and a first housing member; a rod member; an opening provided on a front side of the first housing member, wherein the rod member extends from the first housing member through the opening; a second bracket having a second bonding pad and a second housing member, wherein the second housing member has a through bore extending therethrough to receive the rod member therein; and a spring member secured to the rod member.

The first bracket may be a molar bracket. The second bracket may be a bicuspid bracket. A vertical slot may be provided within a top surface portion of the first housing member. A central recessed portion may be provided within the vertical slot. At least one vertical notch may be provided on opposite sidewalls of the first housing member adjacent the vertical slot.

The rod member may be a push rod member. An end portion of the push rod member may engage an interior end wall provided within an elongate recess extending from the opening of the first housing member. An opposite end portion of the push rod member may be secured to one end of the spring member. An opposite end of the spring member may be secured to a fastener element.

The rod member may be an elongate rod member having an axially extending end portion. An elongated through bore portion may extend from the opening of the first housing member and may receive the axially extending end portion of the elongate rod member therethrough. The spring member may be an axially biased coil spring member provided about a main longitudinal portion of the elongate rod member. The axially biased coil spring member may be held between a sliding stop member provided on the main longitudinal portion of the elongate rod member and the first housing member. An elongate elastomeric member may be secured between an opposite end portion of the elongate rod member and a fastener element.

Another embodiment includes a method of placing a distalizer appliance in a mouth of a patient comprising bonding a first bracket on a molar, the first bracket having a first bonding pad and a first housing member, wherein the first housing member has an opening provided on a front side of the first housing member; placing a push rod member within the first housing member through the opening on the front side of the first housing member; positioning the push rod member with respect to a bicuspid; testing a length of the push rod member for placement of a second bracket on the bicuspid; removing the push rod member from the first bracket; bonding the second bracket on the bicuspid, the second bracket having a second bonding pad and a second housing member, wherein the second housing member has a through bore extending therethrough to receive the push rod member therein; placing the push rod member through the second bracket and into the first bracket; testing position of the push rod member with respect to the first bracket and the second bracket; identifying a position of a fastener element on a jaw of the patient; removing the push rod member from the first bracket and the second bracket; placing the fastener element in the position identified on the jaw of the patient; placing the push rod member through the second bracket; placing a sliding stop member over an end portion of the push rod member; sliding the end portion of the push rod member into the first bracket; configuring the sliding stop member to be adjacent to the molar having the first bracket bonded thereto; and securing a spring member to an opposite end portion of the push rod member at one end thereof and to the fastener element at an opposite end thereof.

In another embodiment, the method may further comprise detaching the spring member from the push rod member and removing the push rod member from the sliding stop member and the second bracket. The bicuspid may be a first bicuspid and the method may further comprise bonding an additional second bracket on a second bicuspid. The method may further comprise placing the push rod member through the second bracket, the additional second bracket and the sliding stop member, and into the first bracket. The method may further comprise reattaching the spring member to the opposite end portion of the push rod member at the one end thereof and to the fastener element at the opposite end thereof.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a side view of a distalizer appliance according to an embodiment;

FIG. 2 is a side view of a distalizer appliance according to an embodiment;

FIG. 3A is a top view of a molar bracket according to an embodiment;

FIG. 3B is a side view of a molar bracket according to an embodiment;

FIG. 3C is an end view of a molar bracket according to an embodiment;

FIG. 3D is a top view of a molar bracket according to an embodiment;

FIG. 3E is a side view of a molar bracket according to an embodiment;

FIG. 4A is a top view of a bicuspid bracket according to an embodiment;

FIG. 4B is a side view of a bicuspid bracket according to an embodiment;

FIG. 4C is an end view of a bicuspid bracket according to an embodiment;

FIG. 5 is a top view of a molar bracket, a bicuspid bracket, and a rod member according to an embodiment;

FIG. 6 is a top view of a molar bracket, a bicuspid bracket, and a rod member according to an embodiment;

FIG. 7A is a top view of a bicuspid bracket according to an embodiment;

FIG. 7B is an end view of a bicuspid bracket according to an embodiment;

FIG. 7C is a side view of a bicuspid bracket according to an embodiment;

FIG. 7D is a top view of a bicuspid bracket according to an embodiment;

FIG. 8A is a top view of a bicuspid bracket according to an embodiment;

FIG. 8B is an end view of a bicuspid bracket according to an embodiment;

FIG. 8C is a side view of a bicuspid bracket according to an embodiment;

FIG. 9A is a top view of a bicuspid bracket according to an embodiment;

FIG. 9B is an end view of a bicuspid bracket according to an embodiment;

FIG. 9C is a side view of a bicuspid bracket according to an embodiment;

FIG. 10A is a top view of a bicuspid bracket according to an embodiment;

FIG. 10B is an end view of a bicuspid bracket according to an embodiment;

FIG. 10C is a side view of a bicuspid bracket according to an embodiment;

FIG. 10D is an end view of a bicuspid bracket according to an embodiment;

FIG. 11 is a side view of a molar bracket according to an embodiment;

FIG. 12 is a side view of a molar bracket with a rod member according to an embodiment;

FIG. 13 is a side view of a molar bracket and a bicuspid bracket according to an embodiment;

FIG. 14 is a side view of a molar bracket, a bicuspid bracket, and a rod member according to an embodiment;

FIG. 15 is a side view of a molar bracket, a bicuspid bracket, and a fastener element according to an embodiment;

FIG. 16 is a side view of a molar bracket, a bicuspid bracket, a rod member, and a fastener element according to an embodiment;

FIG. 17 is a side view of a molar bracket, a bicuspid bracket, a rod member with a sliding stop member and a fastener element according to an embodiment;

FIG. 18 is a side view of a distalizer appliance according to an embodiment;

FIGS. 19A and 19B are side views of a distalizer appliance according to an embodiment;

FIGS. 20A, 20B and 20C are side views of a distalizer appliance according to an embodiment;

FIGS. 21A, 21B and 21C are side views of a distalizer appliance according to an embodiment;

FIG. 22 is a perspective view of a distalizer appliance according to an embodiment; and

FIGS. 23A and 23B are block diagrams of steps of a method of using a distalizer appliance according to an embodiment.

### DETAILED DESCRIPTION OF EMBODIMENTS OF THE INVENTION

As discussed above, embodiments of the present invention relate to a distalizer appliance. Generally, a distalizer appliance is a fixed orthodontic appliance used to distalize molars on the upper and/or lower arches of a patient's mouth. The distalizer appliance of the present invention may be used on one side or both sides of the mouth concurrently. The distalizer appliance of the present invention may also be used on the upper arch, lower arch or both arches simultaneously. The distalizer appliance of the present invention does not require tooth-borne anchorage. The distalizer appliance of the present invention moves only a few teeth simultaneously, thus requiring less force and more rapid movement.

The use of the distalizer appliance of the present invention is flexible in its timing during the treatment process, allowing the distalizer appliance to be used alone at the start of treatment, concurrently with braces already placed, and/or at any stage that the orthodontist deems necessary. The distalizer appliance of the present invention may be placed at the initial patient visit without any additional lab work or other requirements. Due to the ease of placement, any repairs needed are also relatively easy. Since the distalizer appliance of the present invention is based on a system of separate components, any component can be swapped out or replaced as needed to help keep the overall cost minimal. Because of its low profile of the distalizer appliance, it is easy to keep clean and minimizes patient discomfort. The force used to move the teeth is directly placed on the necessary teeth and not the unnecessary teeth, thus allowing the most efficient tooth movement possible.

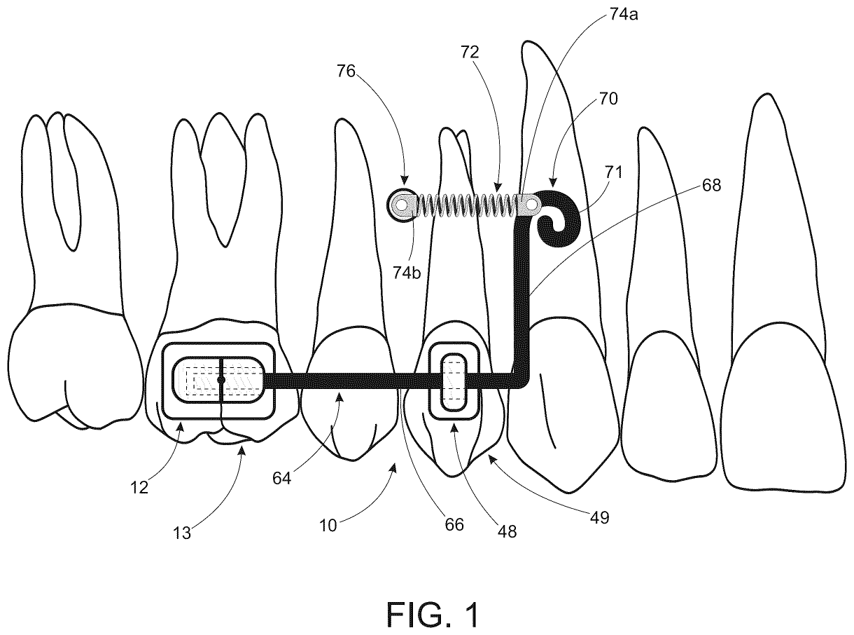

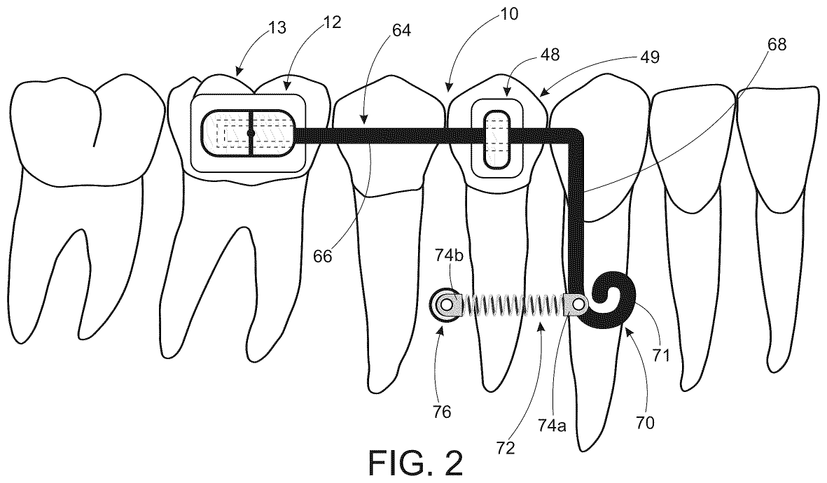

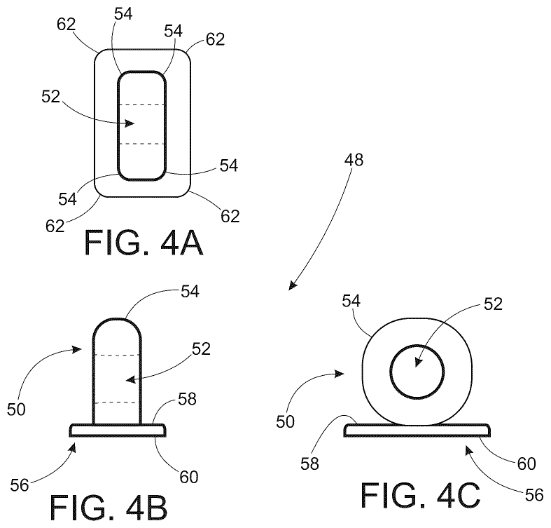

Referring to FIGS. 1-4, a first distalizer appliance 10 is provided with a first bracket 12 (acting as a fulcrum) and is configured to be secured to a molar 13. The first distalizer appliance 10 is provided with a second bracket 48 (acting as a guide sleeve) and is configured to be secured to a bicuspid 49. A push rod member 64 (acting as a driver) extends from the first bracket 12 and through the second bracket 48. The push rod member 64 is provided with a thickness to minimize unwanted flexing and/or deformation.

The push rod member 64 has a first end portion 70 which is secured to a spring member 72 at one end 74a thereof. An opposite end 74b of the spring member 72 is secured to a first fastener element 76 such as mini-screw or temporary anchorage device (TAD). Spring member 72 may be available in at least two different force levels with at least two different lengths.

The first bracket 12 is provided with a first bonding pad 14 having a first housing member 16 secured thereto. The first housing member 16 is provided with an elongate recess 18 having an opening 20 extending about an end wall 22 on a front side 21 thereof. The elongate recess 18 is provided with an interior end wall 24, an arcuate top wall 26, a flat bottom wall 28 and a pair of flat side walls 30. A plurality of first rounded surface portions 32 is provided about the first housing member 16. A top surface portion 40 (facial surface) is provided on the first housing member 16 of the first bracket 12. A vertical slot 42 having a central recessed portion 44 is provided in a middle portion 46 of the top surface portion 40. The first bonding pad 14 is provided with first upper and lower surface portions 34,36 and a plurality of first rounded corners 38 thereabout.

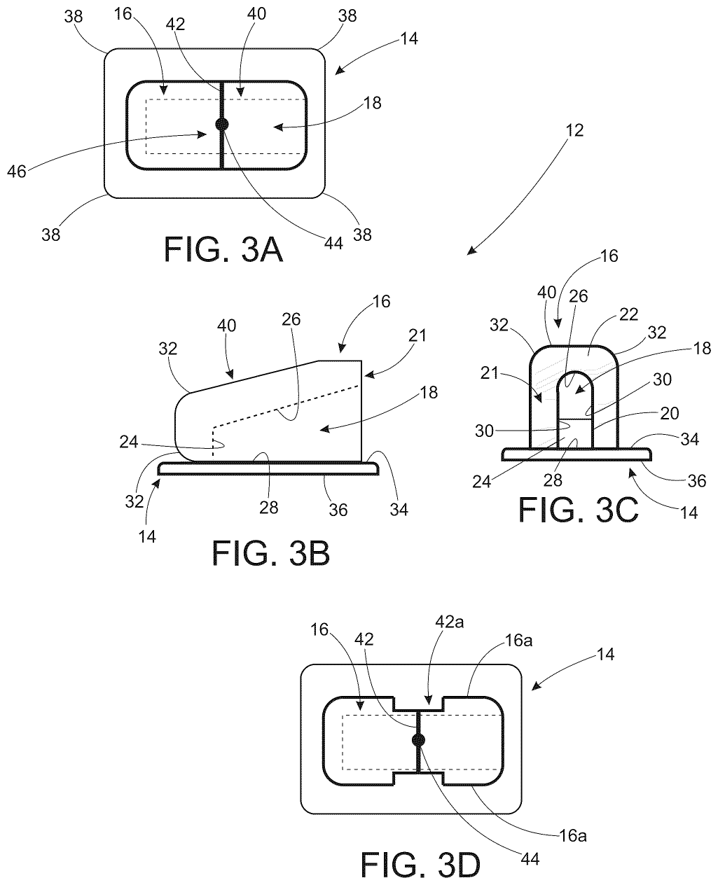

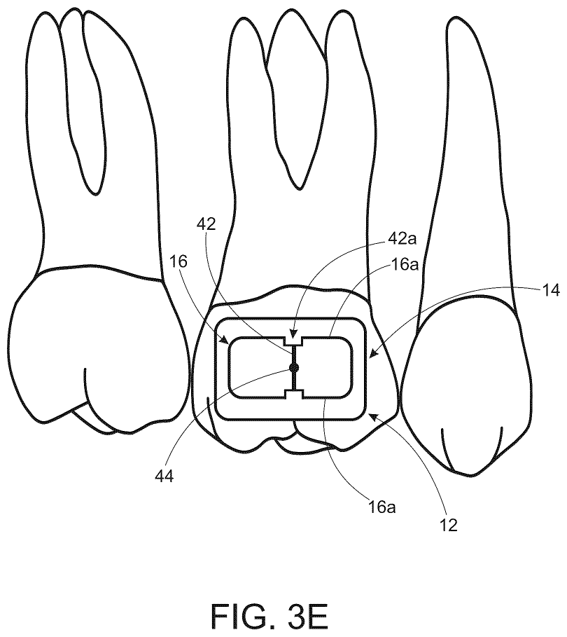

In another embodiment, lower portion 36 is provided with contours and/or bumps along with concave and/or convex surfaces (not shown) in order to substantially match contours of an outer surface of a tooth (not shown). In another embodiment, as shown in FIGS. 3D and 3E, at least one vertical notch 42a is provided on opposite sidewalls 16a of the first housing member 16 adjacent the vertical slot 42. The at least one vertical notch 42a on opposite sidewalls 16a allows for improved placement and/or bonding of the first bracket 12.

The second bracket 48 is provided with a second bonding pad 56 having a second housing member 50 (donut-shaped) secured thereto. The second housing member 50 is provided with a first through bore 52 extending therethrough. A silicone insert (not shown) may be added within the first through bore 52 of the second housing member 50 to increase friction during lateral movements. A plurality of second rounded surface portions 54 is provided about the second housing member 50. The second bonding pad 56 is provided with second upper and lower surface portions 58,60 and a plurality of second rounded corners 62 thereabout.

The push rod member 64 is provided with a first main longitudinal portion 66 and a transverse portion 68. The transverse portion 68 is provided with the first end portion 70 having a curved portion 71. The curved portion 71 helps to minimize gingival or cheek irritation and to discourage removal of spring member 72 by patient (or inadvertent dislodgement).

The spring member 72 extends between the curved portion 71 of the first end portion 70 and the first fastener element 76. The transverse portion 68 may be extended to a height aligned with a center of mass of the molar 13 to be moved. The first main longitudinal portion 66 of push rod member 64 may be bent to aid in placement into the first bracket 12.

The first bracket 12 and the second bracket 48 is contoured near the first bonding pad 14 and the second bonding pad 56, respectively, to allow for a metal ligature and/or an elastomeric thread, tubing, and/or chain, to fit snugly. The first bracket 12 may be attached to any molar tooth. The second bracket 48 may be attached to any bicuspid tooth. The first bracket 12 is universal for all first and second molars (tooth numbers 6 and 7 (Palmer dental notation system)). The first bonding pad 14 and the second bonding pad 56 are sized for maximum tooth retention. Push rod member 64 may be available in multiple sizes. For example, six sizes, two different heights of transverse portion 68 with three different lengths of the first main longitudinal portion 66.

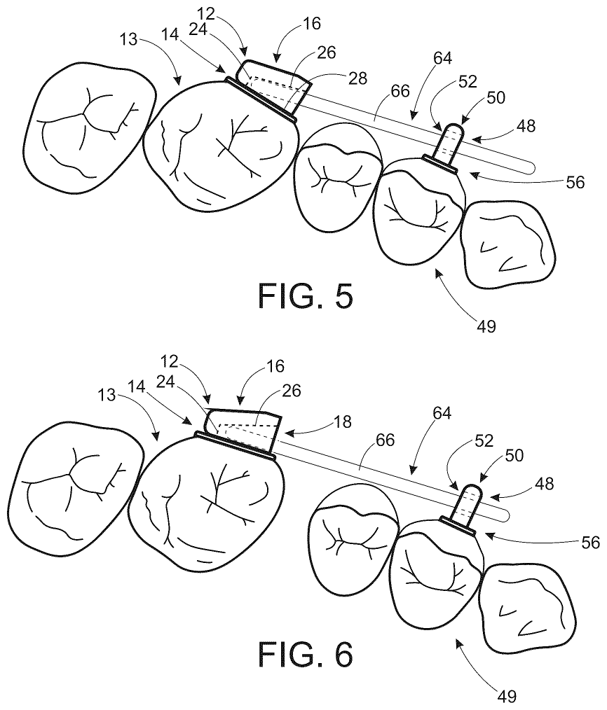

FIGS. 5 and 6 show first bracket 12 and second bracket 48 having push rod member 64 extending therebetween. The first bracket 12 is bonded to the molar 13 via the first bonding pad 14. The second bracket 48 is bonded to the bicuspid 49 via the second bonding pad 56. The push rod member 64 is shown in a first position within the first bracket 12 and the second bracket 48 (See FIG. 5) and a second position within the first bracket 12 and the second bracket 48 (See FIG. 6). In FIG. 5, placement of push rod member 64 in first bracket 12 against the interior end wall 24 allows for mesial rotation of the molar 13. In FIG. 6, distal rotation of the molar 13 after activation of push rod member 64 in a lower position within the first bracket 12.

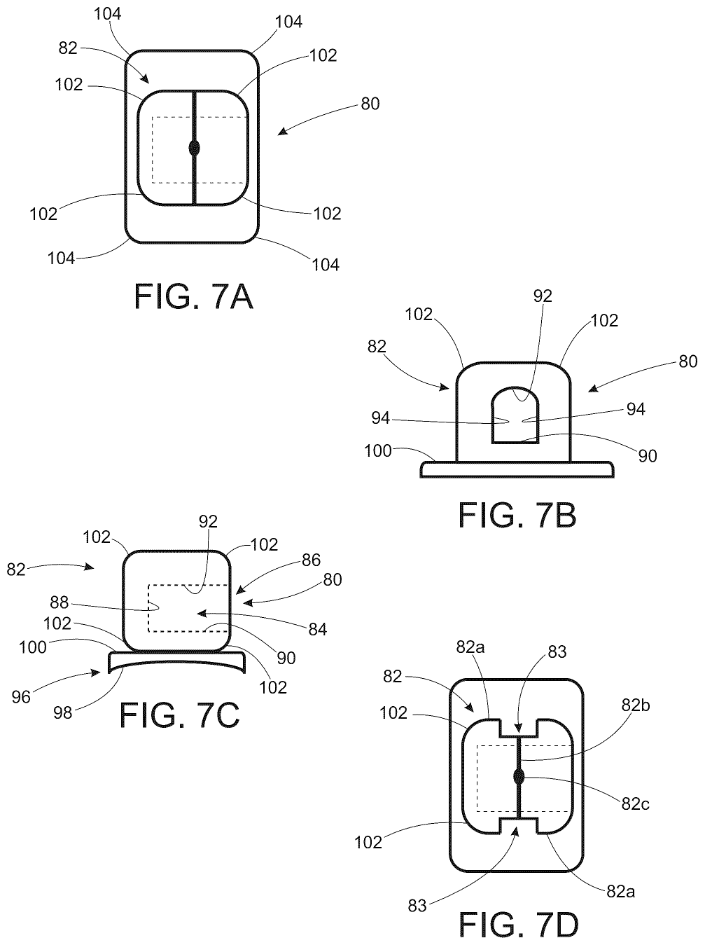

In another embodiment, as shown in FIGS. 7A-7C, a third bracket 80 (acting as a fulcrum) is configured to be secured to a bicuspid (not shown). Third bracket 80 is provided with a third housing member 82 (cubic-shaped) having a rectangular-shaped recess 84 provided with a partially rounded opening 86 at one end and an interior wall portion 88 at an opposite end. The rectangular-shaped recess 84 is provided with a flat planar bottom wall portion 90, an arcuate upper wall portion 92 and flat planar side wall portions 94. A third bonding pad 96 is provided with an arcuate lower surface 98 and a flat planar upper surface 100. The third housing member 82 is provided with a plurality of third rounded surface portions 102. The third bonding pad 96 is provided with a plurality of third rounded corners 104. In another embodiment shown in FIG. 7D, at least one vertical notch 83 is provided on opposite sidewalls 82a of third housing member 82 adjacent a vertical slot 82b having a central recessed portion 82c.

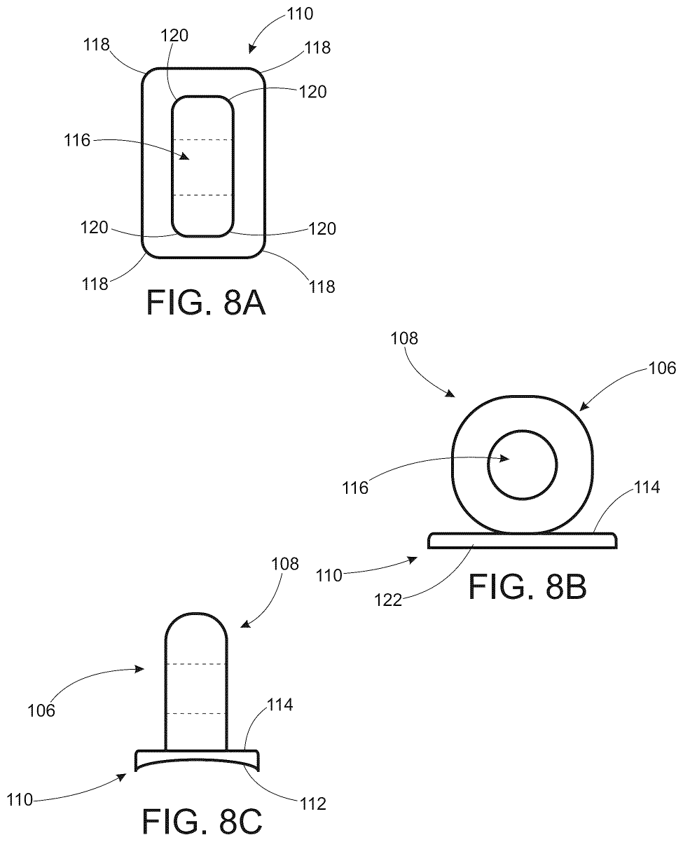

In additional embodiments as shown in FIGS. 8-10, a fourth bracket 106, 106a, 106b (acting as a guide sleeve) is configured to be secured to a bicuspid (not shown). Fourth bracket 106, 106a, 106b is provided with a fourth housing member 108, 108a, 108b (donut-shaped) secured to a fourth bonding pad 110, 110a, 110b. The fourth bonding pad 110, 110a, 110b has an arcuate lower surface 112, 112a, 112b and a flat planar upper surface 114, 114a, 114b. Each fourth housing member 108, 108a, 108b is provided with a second through bore 116, 116a, 116b extending therethrough. The fourth bonding pad 110, 110a, 110b is provided with a plurality of rounded corners 118, 118a, 118b. Each fourth housing member 108, 108a, 108b is provided with a plurality of rounded surface portions 120, 120a, 120b.

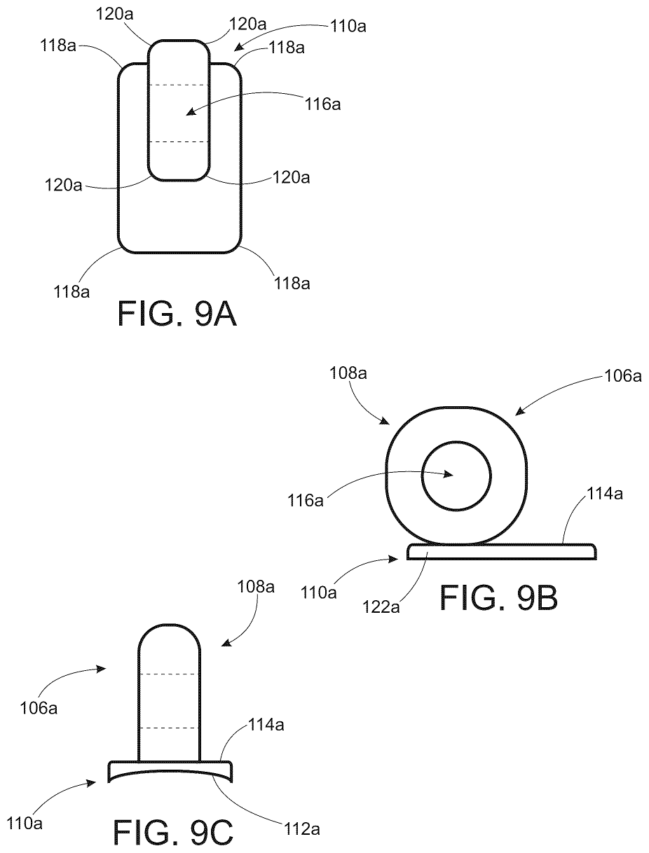

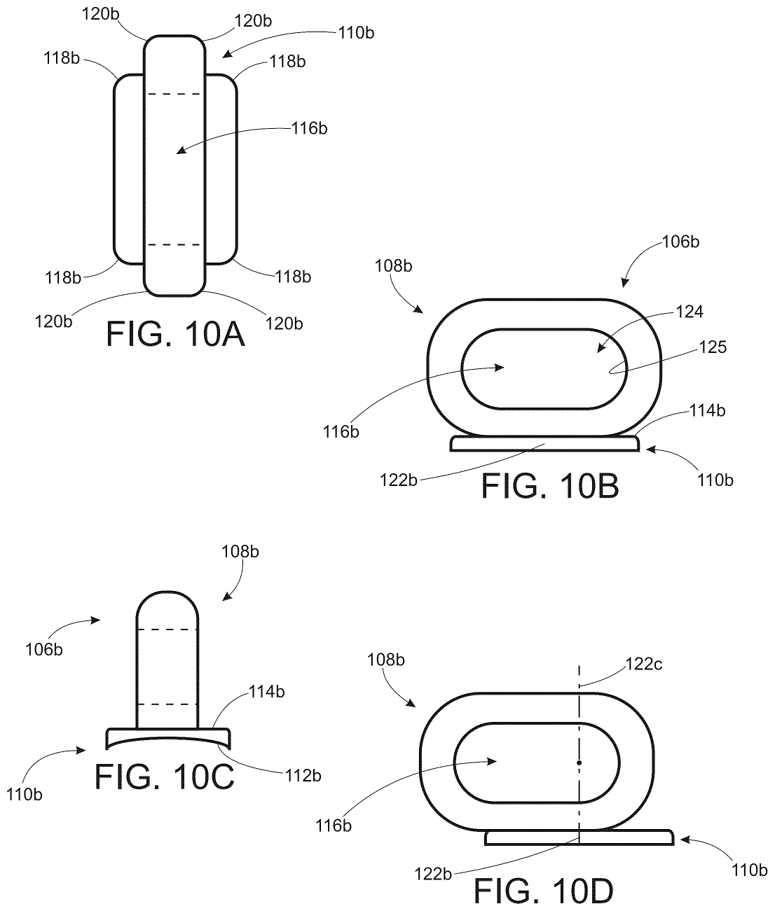

The fourth housing member 108 is positioned and secured to a central portion 122 of the flat planar upper surface 114 (See FIG. 8B). The fourth housing member 108a is positioned and secured to the flat planar upper surface 114a (See FIG. 9B) offset from a central portion 122a of the fourth bonding pad 110a. The fourth housing member 108a offset on the fourth bonding pad 110a allows for unlevel and or unerupted teeth. The fourth housing member 108b is provided with an elongated opening 124 defining a through surface 125 of the through bore 116b (See FIG. 10B). The elongated opening 124 of the fourth housing member 108b allows up and down freedom of movement of the push rod member 64 while restricting lateral motion of the push rod member 64 in order to create additional intrusive or extrusive forces (if so desired). The fourth housing member 108b is positioned and secured to the flat planar upper surface 114b aligned with a central portion 122b of the fourth bonding pad 110b. In another embodiment shown in FIG. 10D, the fourth housing member 108b is positioned offset from the central portion 122b (as indicated by a central line 122a) of the fourth bonding pad 110b.

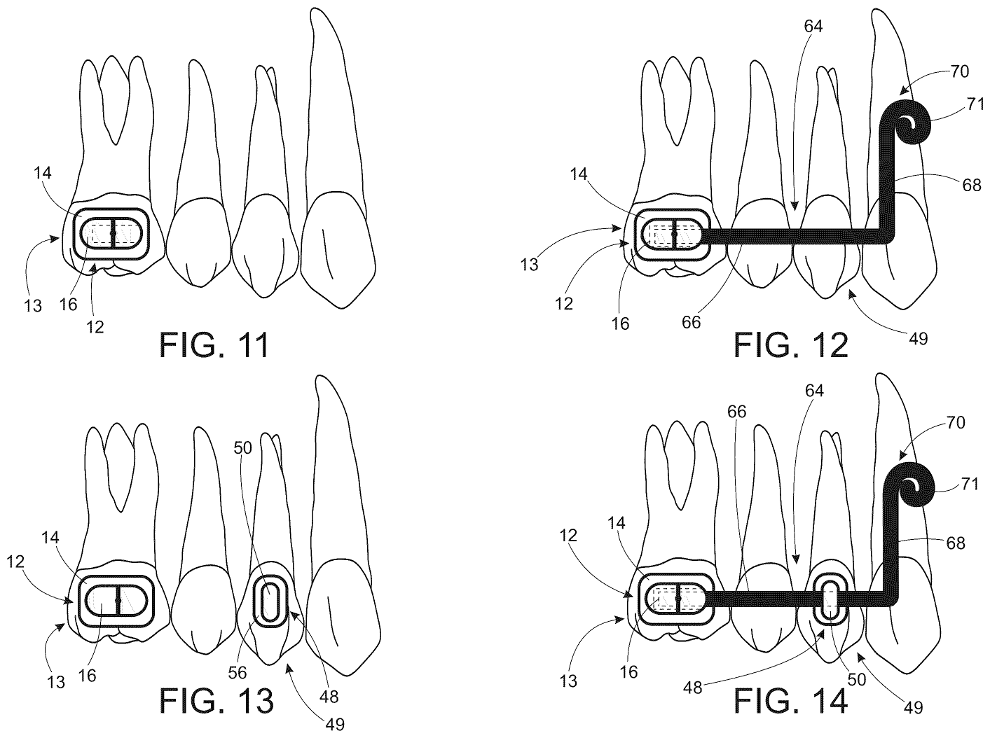

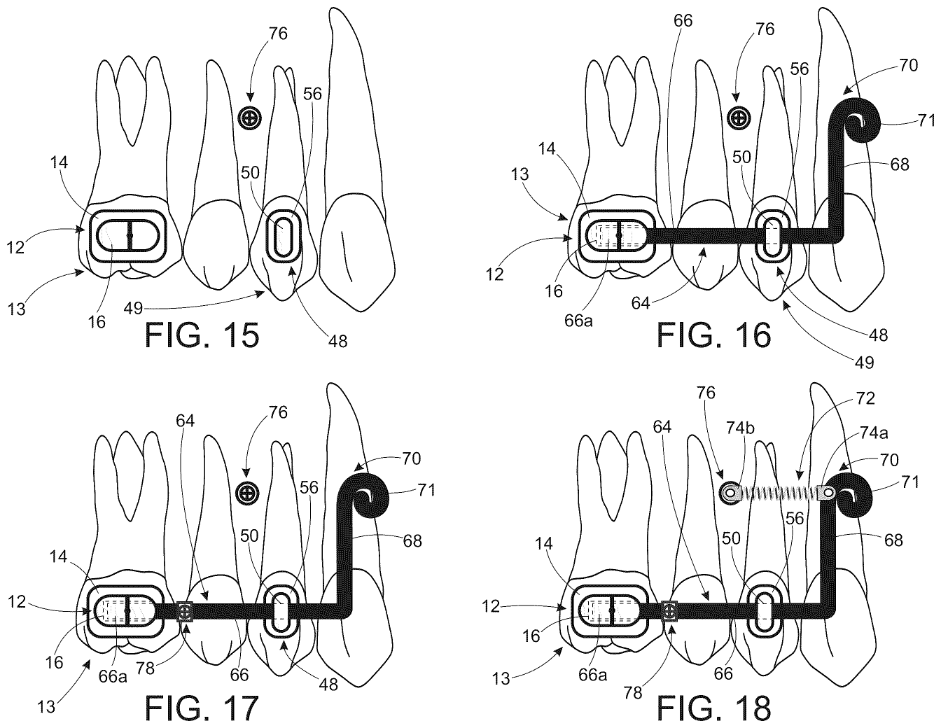

FIGS. 11-18 show the sequence of placement of the elements of the first distalizer appliance of the present invention. The first bracket 12 is bonded on molar 13. The first bracket 12 has the first bonding pad 14 and the first housing member 16. The first housing member 16 has the opening 20 provided on the front side 21 of the first housing member 16. The push rod member 64 is placed within the first housing member 16 through the opening 20 on the front side of the first housing member 16.

The push rod member 64 is positioned with respect to bicuspid 49. A position is found on the bicuspid 49 for placement of second bracket 48 on the bicuspid 49. Push rod member 64 is removed from first bracket 12. The second bracket 48 is bonded on the bicuspid 49. The second bracket 48 has the second bonding pad 56 and the second housing member 50. The second housing member 50 has the first through bore 52 extending therethrough to receive the push rod member 64 therein. The push rod member 64 is placed through the second bracket 48 and into the first bracket 12. The position of the push rod member 64 with respect to the first bracket 12 and the second bracket 48 is tested.

A position of the first fastener element 76 is identified on a jaw of the patient. Push rod member 64 is removed from the first bracket 12 and the second bracket 48. The first fastener element 76 is placed in the position identified on the jaw of the patient. The push rod member 64 is placed through the second bracket. A first sliding stop member 78 is placed over an end portion 66a of the push rod member 64. The end portion 66a of the push rod member 64 is slid into the first bracket 12. The first sliding stop member 78 is configured to be adjacent to the molar 13 having the first bracket 12 bonded thereto. Spring member 72 is secured to the first end portion 70 of the push rod member 64 at one end 74a thereof and to the fastener element 76 at an opposite end 74b thereof.

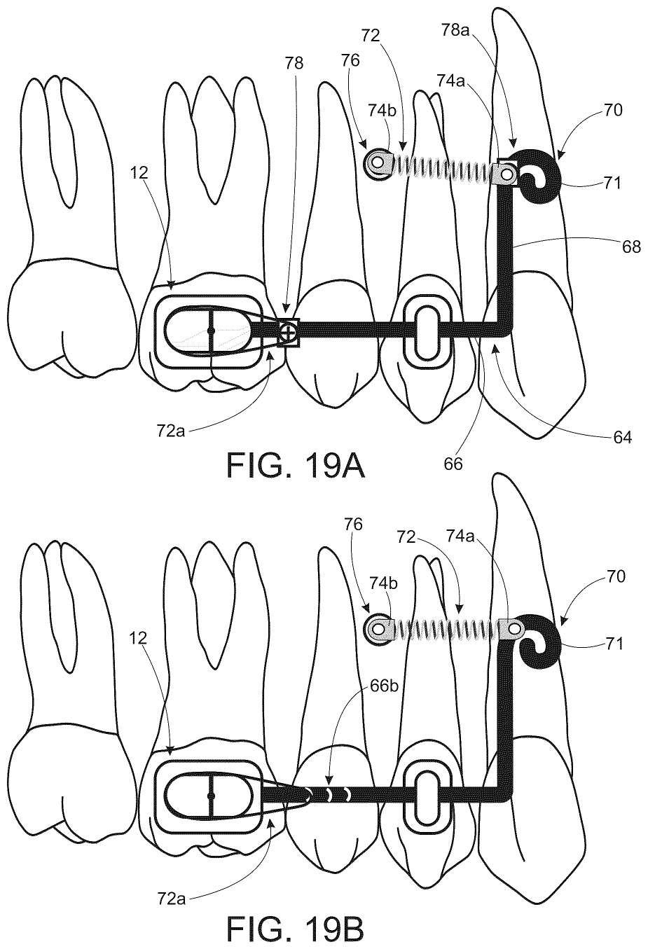

In another embodiment referring to FIGS. 19A and 19B, a second sliding stop member 78a is positioned on transverse portion 68 adjacent curved portion 71 of the first end portion 70. The second sliding stop member 78a may alter the direction of force to allow more extrusive or intrusive molar movements. Spring member 72 is secured at its end 74a to the second sliding stop member 78a. The first sliding stop member 78 (see FIG. 19A) is tied back with tie member 72a (ligature tie) to the first bracket 12 in order to inhibit rotation of the push rod member 64. Tie member 72a is a metal ligature and/or an elastomeric thread, chain and/or tubing. In FIG. 19B, a plurality of cuts 66b is provided in main longitudinal portion 66 of push rod member 64 to allow for engagement with tie member 72a in order to tie back to first bracket 12 and allow for molar tie-back.

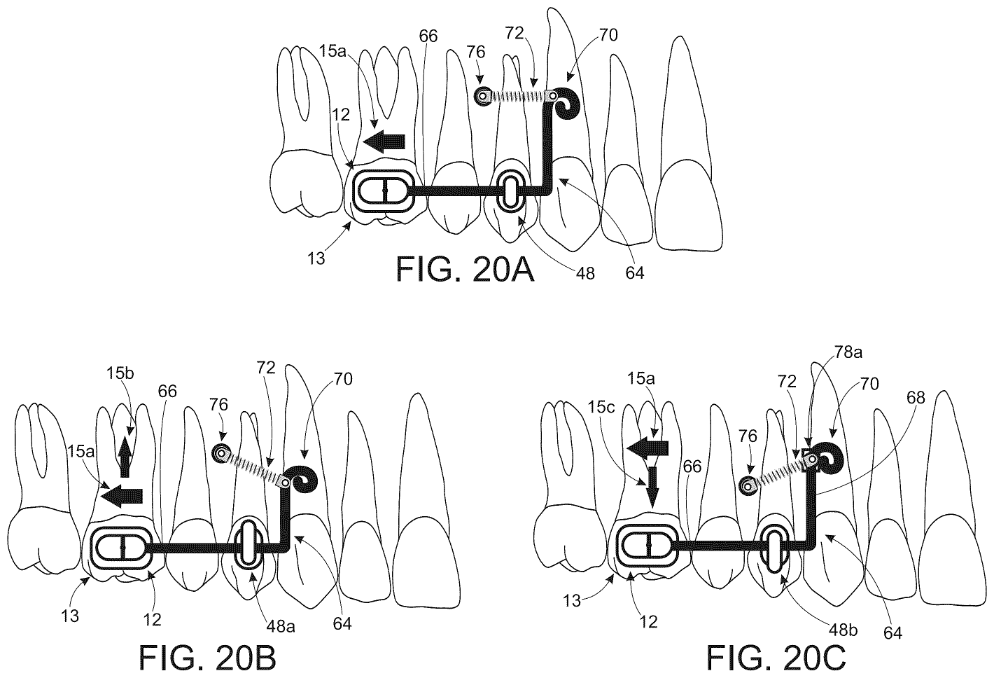

In another embodiment referring to FIGS. 20A, 20B and 20C, various attachment positions of spring member 72 relative to push rod member 64 are shown. In FIG. 20A, spring member 72 is secured between the first fastener element 76 and the first end portion 70 of push rod member 64 so that spring member 72 extends substantially parallel to main longitudinal portion 66 of push rod member 64 which allows for only distal movement, as shown by arrow 15a. In FIG. 20B, spring member 72 is secured in a downwardly angled position relative to the first main longitudinal portion 66 which allows for an upward and backward (high-pull) configuration (superior-distal rotation) as shown by arrows 15a and 15b. In FIG. 20C, spring member 72 is secured in an upwardly angled position relative to the first main longitudinal portion 66 and to the second sliding stop member 78a on transverse portion 68 which allows for a downward and backward (low-pull) configuration (inferior-distal rotation) as shown by arrows 15a and 15c. Second brackets 48a and 48b are provided for the configurations shown in FIGS. 20B and 20C, respectively, in order to allow for vertical movement of push rod member 64 therein.

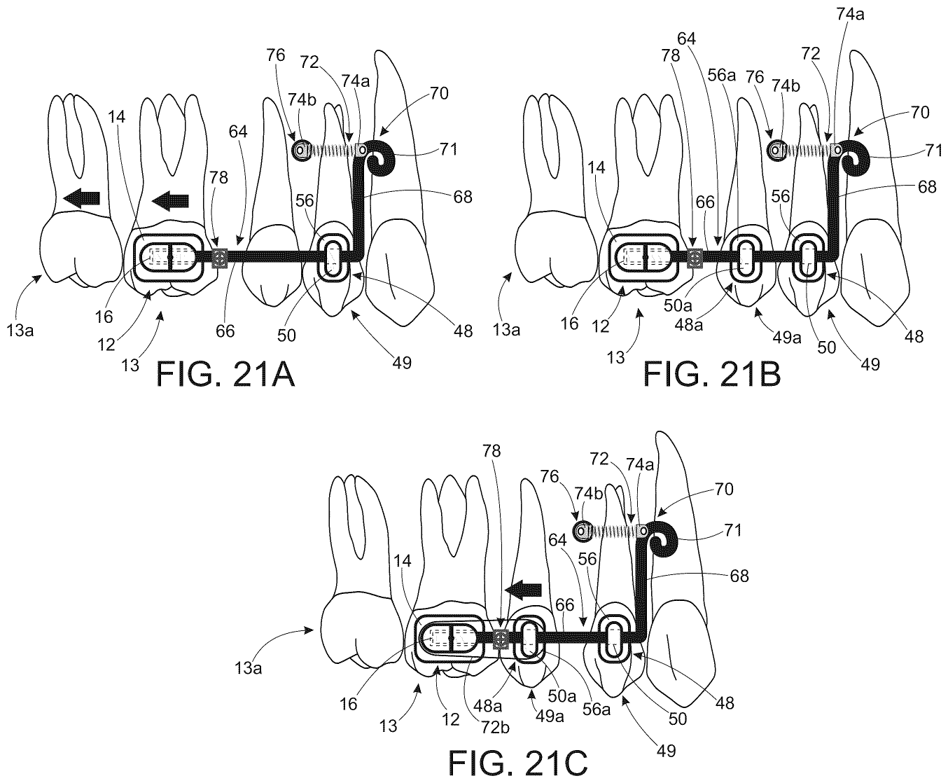

In another embodiment, referring to FIGS. 21A-21C, after distal movement of molars 13, 13a, spring member 72 is detached from the push rod member 64 and the push rod member 64 is removed from the first sliding stop member 78 and the second bracket 48. An additional second bracket 48a is bonded to a second bicuspid 49a to allow distal movement. The push rod member 64 is placed through the second bracket 48, the additional second bracket 48a and the first sliding stop member 78, and into the first bracket 12. The spring member 72 is reattached to the first end portion 70 of the push rod member 64 at the one end 74a thereof and to the first fastener element 76 at the opposite end 74b thereof. An elastomeric chain 72b (power chain) is secured between first housing member 16 and additional second bracket 48a resulting in distal movement of the second bicuspid 49a (See FIG. 21C).

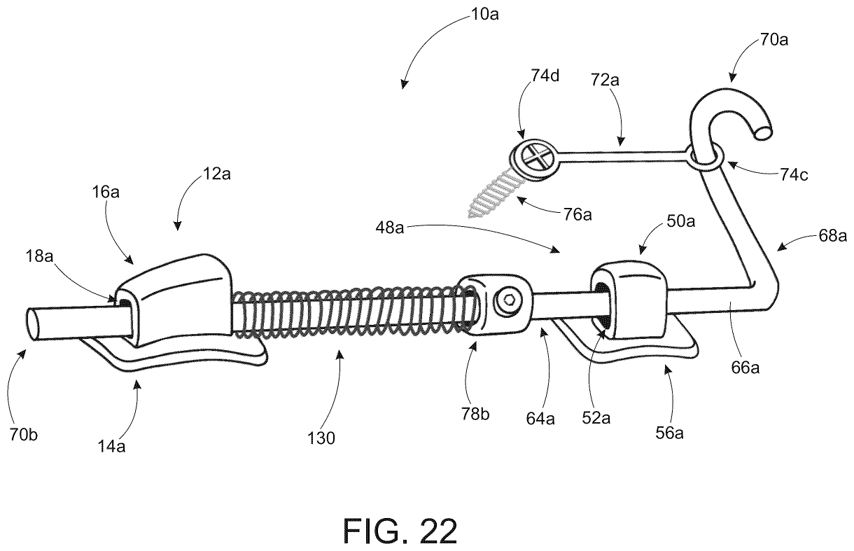

In FIG. 22, a second distalizer appliance 10a is provided with an elongate rod member 64a having a partly curved end portion 70a and a transversely extending portion 68a. An elongate elastomeric member 72a is provided with a first eyelet end portion 74c and a second eyelet end portion 74d. The first eyelet end portion 74c is secured about the transversely extending portion 68a and the second eyelet end portion 74d is secured about a second fastener element 76a in order to provide a secure anchor for the elongate rod member 64a.

The second distalizer appliance 10a is also provided with a fifth bracket 12a and a sixth bracket 48a. The fifth bracket 12a is provided with a fifth bonding pad 14a and a fifth housing member 16a having an elongated through bore portion 18a. The elongated through bore portion 18a receives an axially extending end portion 70b of the elongate rod member 64a. The sixth bracket 48a is provided with a sixth bonding pad 56a and a sixth housing member 50a having a third through bore 52a. The third through bore 52a receives a second main longitudinal portion 66a of the elongate rod member 64a.

The second distalizer appliance 10a is provided with an axially biased coil spring member 130 about the second main longitudinal portion 66a. The axially biased coil spring member 130 provides an outwardly acting bias between the fifth bracket 12a and a third sliding stop member 78b in order to shift or drive the fifth bracket 12a along the axially extending end portion 70b of the elongate rod member 64a.

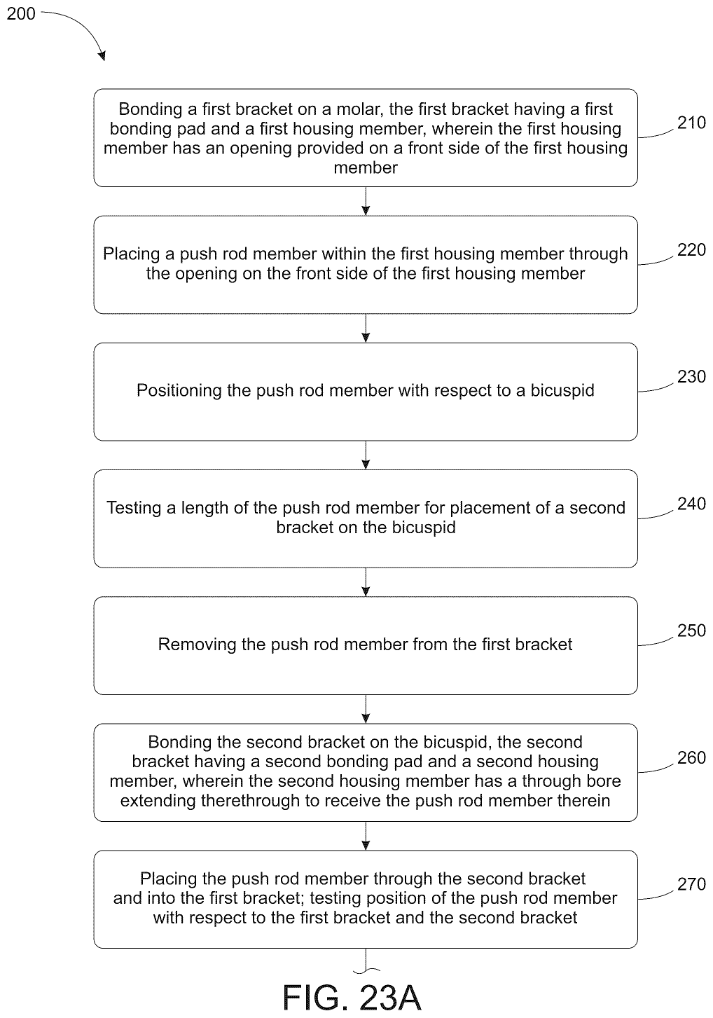

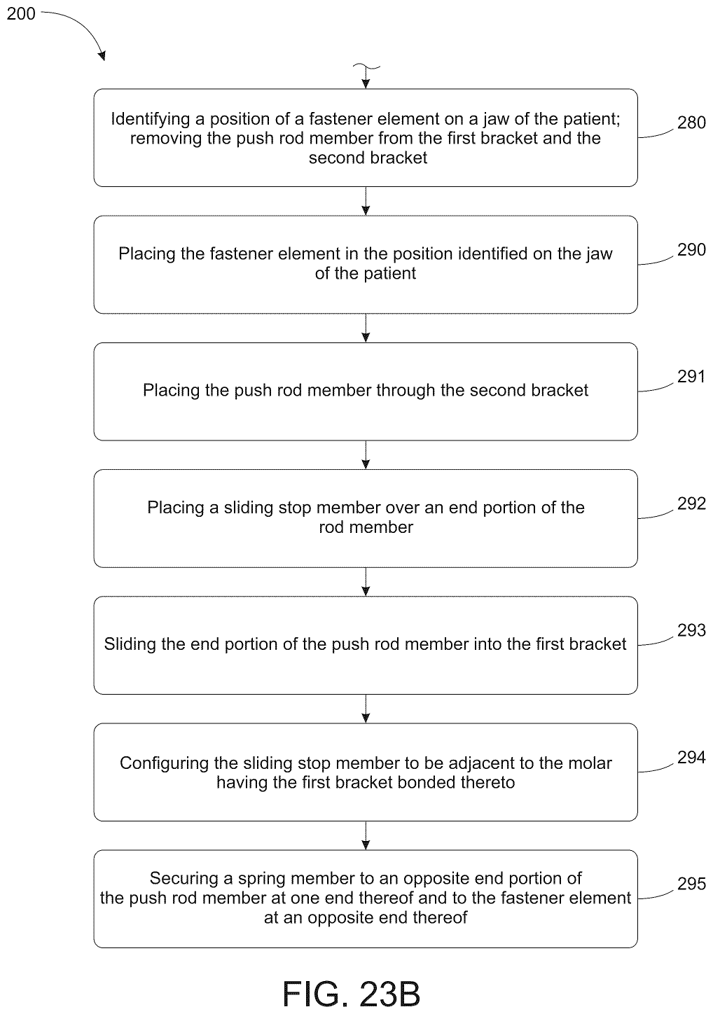

FIGS. 23A and 23B is a block diagram of steps of a method 200 of placing a distalizer appliance in a mouth of a patient. Method 200 comprises bonding a first bracket on a molar, the first bracket having a first bonding pad and a first housing member, wherein the first housing member has an opening provided on a front side of the first housing member (Step 210); placing a push rod member within the first housing member through the opening on the front side of the first housing member (Step 220); positioning the push rod member with respect to a bicuspid (Step 230); testing a length of the push rod member for placement of a second bracket on the bicuspid (Step 240); removing the push rod member from the first bracket (Step 250); bonding the second bracket on the bicuspid, the second bracket having a second bonding pad and a second housing member, wherein the second housing member has a through bore extending therethrough to receive the push rod member therein (Step 260); placing the push rod member through the second bracket and into the first bracket; testing position of the push rod member with respect to the first bracket and the second bracket (Step 270); identifying a position of a fastener element on a jaw of the patient; removing the push rod member from the first bracket and the second bracket (Step 280); placing the fastener element in the position identified on the jaw of the patient (Step 290); placing the push rod member through the second bracket (Step 291); placing a sliding stop member over an end portion of the rod member (Step 292); sliding the end portion of the push rod member into the first bracket (Step 293); configuring the sliding stop member to be adjacent to the molar having the first bracket bonded thereto (Step 294); and securing a spring member to an opposite end portion of the push rod member at one end thereof and to the fastener element at an opposite end thereof (Step 295).

In another embodiment, the method further comprises detaching the spring member from the push rod member and removing the push rod member from the sliding stop member and the second bracket; bonding an additional second bracket on a second bicuspid; placing the push rod member through the second bracket, the additional second bracket and the sliding stop member, and into the first bracket; and reattaching the spring member to the opposite end portion of the push rod member at the one end thereof and to the fastener element at the opposite end thereof.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A distalizer appliance comprising:
a first bracket having a first bonding pad and a first housing member;
a rod member;
an opening provided on a front side of the first housing member, wherein the rod member extends from the first housing member through the opening;
a second bracket having a second bonding pad and a second housing member, wherein the second housing member has a through bore extending therethrough to receive the rod member therein; and
a spring member secured to the rod member.

2. The distalizer appliance of claim 1, wherein the first bracket is a molar bracket.

3. The distalizer appliance of claim 1, wherein the second bracket is a bicuspid bracket.

4. The distalizer appliance of claim 1, wherein a vertical slot is provided within a top surface portion of the first housing member.

5. The distalizer appliance of claim 4, wherein a central recessed portion is provided within the vertical slot.

6. The distalizer appliance of claim 4, wherein at least one vertical notch is provided on opposite sidewalls of the first housing member adjacent the vertical slot.

7. The distalizer appliance of claim 1, wherein the rod member is a push rod member.

8. The distalizer appliance of claim 7, wherein an end portion of the push rod member engages an interior end wall provided within an elongate recess extending from the opening of the first housing member.

9. The distalizer appliance of claim 8, wherein an opposite end portion of the push rod member is secured to one end of the spring member.

10. The distalizer appliance of claim 9, wherein an opposite end of the spring member is secured to a fastener element.

11. The distalizer appliance of claim 1, wherein the rod member is an elongate rod member having an axially extending end portion.

12. The distalizer appliance of claim 11, wherein an elongated through bore portion extends from the opening of the first housing member and receives the axially extending end portion of the elongate rod member therethrough.

13. The distalizer appliance of claim 12, wherein the spring member is an axially biased coil spring member provided about a main longitudinal portion of the elongate rod member.

14. The distalizer appliance of claim 13, wherein the axially biased coil spring member is held between a sliding stop member provided on the main longitudinal portion of the elongate rod member and the first housing member.

15. The distalizer appliance of claim 14, wherein an elongate elastomeric member is secured between an opposite end portion of the elongate rod member and a fastener element.

16. A method of placing a distalizer appliance in a mouth of a patient comprising:
bonding a first bracket on a molar, the first bracket having a first bonding pad and a first housing member, wherein the first housing member has an opening provided on a front side of the first housing member;
placing a push rod member within the first housing member through the opening on the front side of the first housing member;
positioning the push rod member with respect to a bicuspid;
testing a length of the push rod member for placement of a second bracket on the bicuspid;
removing the push rod member from the first bracket;
bonding the second bracket on the bicuspid, the second bracket having a second bonding pad and a second housing member, wherein the second housing member has a through bore extending therethrough to receive the push rod member therein;
placing the push rod member through the second bracket and into the first bracket;
testing position of the push rod member with respect to the first bracket and the second bracket;
identifying a position of a fastener element on a jaw of the patient;
removing the push rod member from the first bracket and the second bracket;
placing the fastener element in the position identified on the jaw of the patient;
placing the push rod member through the second bracket;
placing a sliding stop member over an end portion of the push rod member;
sliding the end portion of the push rod member into the first bracket;
configuring the sliding stop member to be adjacent to the molar having the first bracket bonded thereto; and
securing a spring member to an opposite end portion of the push rod member at one end thereof and to the fastener element at an opposite end thereof.

17. The method of claim 16, further comprising detaching the spring member from the push rod member and removing the push rod member from the sliding stop member and the second bracket.

18. The method of claim 17, wherein the bicuspid is a first bicuspid and further comprising bonding an additional second bracket on a second bicuspid.

19. The method of claim 18, further comprising placing the push rod member through the second bracket, the additional second bracket and the sliding stop member, and into the first bracket.

20. The method of claim 19, further comprising reattaching the spring member to the opposite end portion of the push rod member at the one end thereof and to the fastener element at the opposite end thereof.
